(19) United States
(12) Patent Application Publication
(10) Pub. No.: US 2024/0036511 A1
(43) Pub. Date: Feb. 1, 2024

(54) DRIVING FORCE TRANSMISSION MECHANISM, TONER CONVEYING DEVICE, AND IMAGE FORMING APPARATUS

(71) Applicant: KYOCERA Document Solutions Inc., Osaka (JP)

(72) Inventor: Taisei HAYAKAWA, Osaka (JP)

(73) Assignee: KYOCERA Document Solutions Inc., Osaka (JP)

(21) Appl. No.: 18/360,715

(22) Filed: Jul. 27, 2023

(30) Foreign Application Priority Data
Jul. 28, 2022 (JP) 2022-120707

(51) Int. Cl. G03G 21/16; G03G 21/10; G03G 15/08

(52) U.S. Cl. CPC G03G 21/1647; G03G 21/105; G03G 15/0891

(57) ABSTRACT

A driving force transmission mechanism transmits a driving force fed from a driving source to a rotary member. The driving force transmission mechanism includes a driving gear, a drive-side coupling, an output-side coupling, and an urging member. The driving gear rotates by being fed with the driving force from the driving source, and has a hollow space along the rotation axis direction. The drive-side coupling is inserted in the hollow space in the driving gear, and rotates together with the driving gear. The output-side coupling is integral with the rotary member, and can couple with the drive-side coupling along the rotation axis direction. The urging member urges one of the drive-side coupling and the output-side coupling toward the other along the rotation axis direction.

### INCORPORATION BY REFERENCE

This application is based on and claims the benefit of priority from Japanese Patent Application No. 2022-120707 filed on Jul. 28, 2022, the contents of which are hereby incorporated by reference.

### BACKGROUND

The present disclosure relates to a driving force transmission mechanism for transmitting a driving force fed from a driving source to a rotary member, to a toner conveying device employing a driving force transmission mechanism, and to an image forming apparatus incorporating a toner conveying device.

An image forming apparatus incorporates a driving force transmission mechanism that transmits a driving force fed from a driving source to a rotary member to rotate it. The rotary member can be, for example, a photosensitive drum, a toner conveying screw, or a waste toner conveying screw.

### SUMMARY

According to one aspect of the present disclosure, a driving force transmission mechanism transmits a driving force fed from a driving source to a rotary member. The driving force transmission mechanism includes a driving gear, a drive-side coupling, an output-side coupling, and an urging member. The driving gear rotates by being fed with the driving force from the driving source, and has a hollow space along a rotation axis direction. The drive-side coupling is inserted in the hollow space in the driving gear, and rotates together with the driving gear. The output-side coupling is integral with the rotary member, and can couple with the drive-side coupling along the rotation axis direction. The urging member urges one of the drive-side coupling and the output-side coupling toward the other along the rotation axis direction.

This and other objects of the present disclosure, and the specific benefits obtained according to the present disclosure, will become apparent from the description of embodiments which follows.

### BRIEF DESCRIPTION OF THE DRAWINGS

FIG. 1 is a side view schematically showing the internal construction of an image forming apparatus according to one embodiment of the present disclosure.

FIG. 2 is a perspective view showing a waste toner conveying device according to one embodiment of the present disclosure.

FIG. 3 is a sectional view showing a waste toner conveying device according to one embodiment of the present disclosure.

FIG. 4A is a sectional view showing a driving force transmission mechanism according to one embodiment of the present disclosure.

FIG. 4B is a sectional view showing a driving force transmission mechanism according to one embodiment of the present disclosure.

FIG. 5A is a perspective view showing a driving gear in a driving force transmission mechanism according to one embodiment of the present disclosure.

FIG. 5B is a sectional view showing a driving gear in a driving force transmission mechanism according to one embodiment of the present disclosure.

FIG. 5C is a perspective view showing a drive-side coupling in a driving force transmission mechanism according to one embodiment of the present disclosure.

FIG. 6A is a perspective view showing an output-side coupling in a driving force transmission mechanism according to one embodiment of the present disclosure.

FIG. 6B is a perspective view showing a rear wall of a housing of a waste toner conveying device according to one embodiment of the present disclosure.

### DETAILED DESCRIPTION

An embodiment of the present disclosure will be described below with reference to the accompanying drawings.

Today, with size reduction of image forming apparatuses in mind, demand is rising for space saving. Accordingly, an object of the present disclosure is to provide a driving force transmission mechanism that allows space saving, a toner conveying device that employs such a driving force transmission mechanism, and an image forming apparatus that incorporates such a toner conveying device.

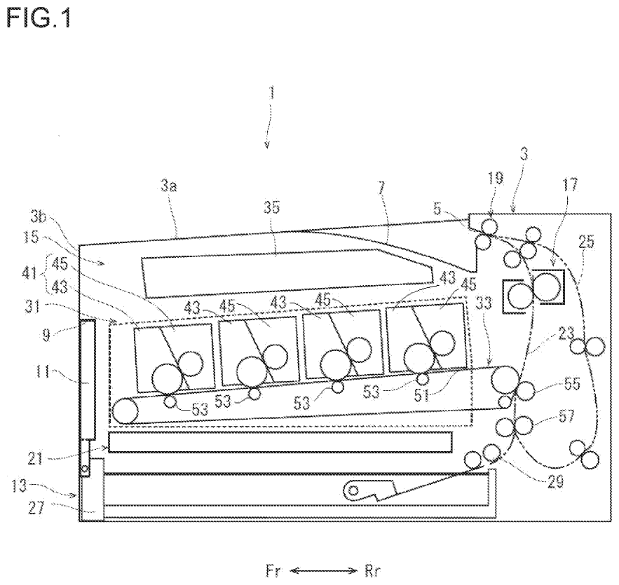

With reference to FIG. 1, an image forming apparatus 1 will be described. FIG. 1 is a side view of the image forming apparatus 1, schematically showing its internal construction. In this and other diagrams, the symbols “Fr,” “Rr,” “L,” and “R” indicate the front, rear, left, and right sides, respectively, of the image forming apparatus 1.

The image forming apparatus 1 has a body 3 with a hollow space substantially in the shape of a rectangular parallelepiped. The top plate 3a of the body 3 has a sheet discharge port 5 and, in front of it, a discharge tray 7. The front side plate 3b of the body 3 has an opening 9 formed in it. The opening 9 can be opened and closed with a front cover 11.

In the hollow space of the body 3 are a sheet feed section 13, an image forming section 15 of an electrophotographic type, a fixing device 17, a discharge device 19, and a waste toner conveying device 21. Also in the hollow space are a main conveyance passage 23 and a reversal conveyance passage 25 for sheet conveyance.

The sheet feed section 13 is disposed in a lower part of the hollow space, and includes a sheet feed cassette 27 in which sheets are stored and a sheet feeding device 29 that feeds a sheet from the sheet feed cassette 27 to the main conveyance passage 23. The sheet feed cassette 27 can be mounted and dismounted through the opening 9 in the front side plate 3b along the front-rear direction. The sheet feeding device 29 is disposed at the upper rear of the sheet feed cassette 27.

The image forming section 15 is disposed in an upper part of the hollow space, and includes an image forming unit 31, an intermediate transfer device 33, and an exposure device 35.

The image forming section 15 includes four individual units 41 corresponding to toners of four colors (yellow, magenta, cyan, black). The individual units 41 each include a drum unit 43, which includes a photosensitive drum on which an electrostatic latent image is formed, and a development unit 45, which develops the electrostatic latent image into a toner image by one-component development. The four individual units 41 are disposed next to each other along the front-rear direction.

The image forming unit 31 can be pulled out through the opening 9 in the front side plate 3b along a pull-out direction pointing frontward. On the occasion of replacement of a development unit 45 depleted of toner or maintenance of the image forming unit 31, the image forming unit 31 is pulled out of the body 3 to be dismounted from the body 3.

The intermediate transfer device 33 includes an endless intermediate transfer belt 51 that carries toner images, four primary transfer rollers 53 that correspond to the four individual units 41, and a secondary transfer roller 55. The intermediate transfer belt 51 is wound around a driving roller, a driven roller, and a tension roller that are disposed apart from each other along the front-rear direction. The intermediate transfer belt 51 is one example of an image carrying member according to the present disclosure. The four primary transfer rollers 53 are arranged next to each other along the front-rear direction in the hollow space inside the intermediate transfer belt 51. The secondary transfer roller 55 is disposed at the rear of the intermediate transfer belt 51. The intermediate transfer belt 51 and the secondary transfer roller 55 form a secondary transfer nip between them.

The intermediate transfer device 33 is disposed under the image forming unit 31. The four primary transfer rollers 53 of the intermediate transfer device 33 face, across the intermediate transfer belt 51, the photosensitive drums of the drum units 43 in the four individual units 41 in the image forming unit 31, and form a primary transfer nip between the intermediate transfer belt 51 and each of the photosensitive drums. The exposure device 35 is disposed over the image forming unit 31.

The fixing device 17 includes a pressing roller and a heating roller, which form a fixing nip between them. The fixing device 17 is disposed above the secondary transfer nip. The discharge device 19 is disposed above the fixing device 17, inward of the discharge port 5.

The waste toner conveying device 21 conveys and collects the waste toner removed from the intermediate transfer belt 51. The waste toner conveying device 21 is disposed in a lower part of the hollow space in the body 3, under the image forming unit 31. Disposing the waste toner conveying device 21 under the image forming unit 31 helps reduce the width of the body 3 along the left-right direction. The waste toner conveying device 21 will be described later.

The main conveyance passage 23 extends from the sheet feeding device 29 in the sheet feed section 13 to the discharge device 19 via the secondary transfer nip and the fixing nip. In the main conveyance passage 23 is disposed, between the sheet feeding device 29 and the secondary transfer nip, a pair of registration rollers 57. The reversal conveyance passage 25 branches off the main conveyance passage 23 downstream of the fixing device 17 and rejoins the main conveyance passage 23 upstream of the pair of registration rollers 57.

Next, image forming operation will be described in brief. In the image forming section 15, through exposure to light carrying image data from the exposure device 35, toner images are formed on the individual units 41 in the image forming unit 31. At the primary transfer nip, the toner images are transferred from the individual units 41 to the intermediate transfer belt 51. Thus, a full-color toner image is formed on the intermediate transfer belt 51.

On the other hand, in the sheet feed section 13, a sheet is conveyed from the sheet feed cassette 27 to the main conveyance passage 23 by the sheet feeding device 29. The sheet is conveyed, with appropriate timing, to the secondary transfer nip by the pair of registration rollers 57. At the secondary transfer nip, the toner image formed on the intermediate transfer belt 51 is transferred to one side of the sheet. The sheet is conveyed along the main conveyance passage 23 to the fixing device 17, where at the fixing nip the toner image is fixed to the sheet. The sheet is conveyed further to the discharge device 19 to be discharged onto the discharge tray 7 through the discharge port 5 by the discharge device 19.

When subjected to duplex printing, the sheet having the toner image fixed to one side is conveyed from the main conveyance passage 23 to the reversal conveyance passage 25 and, at the secondary transfer nip, a toner image is transferred to the other side of the sheet. After that, the toner image is fixed to the other side of the sheet in the fixing device 17. The sheet is then conveyed to the discharge device 19 to be discharged onto the discharge tray 7 through the discharge port 5 by the discharge device 19.

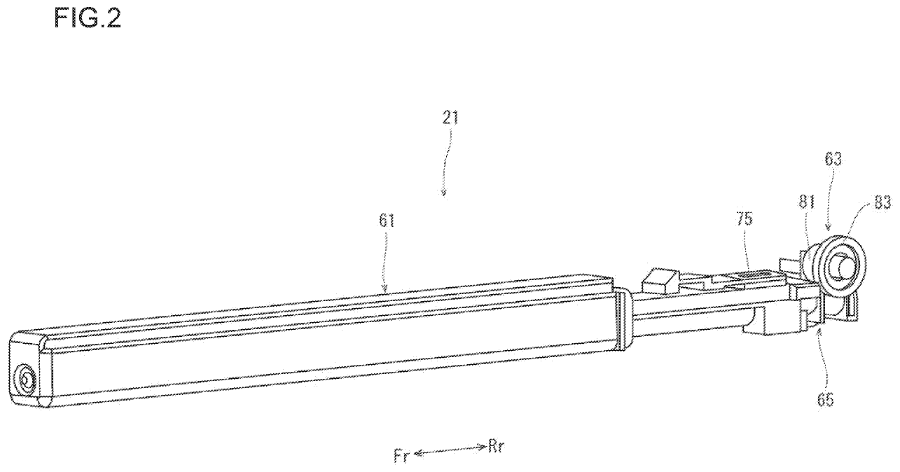

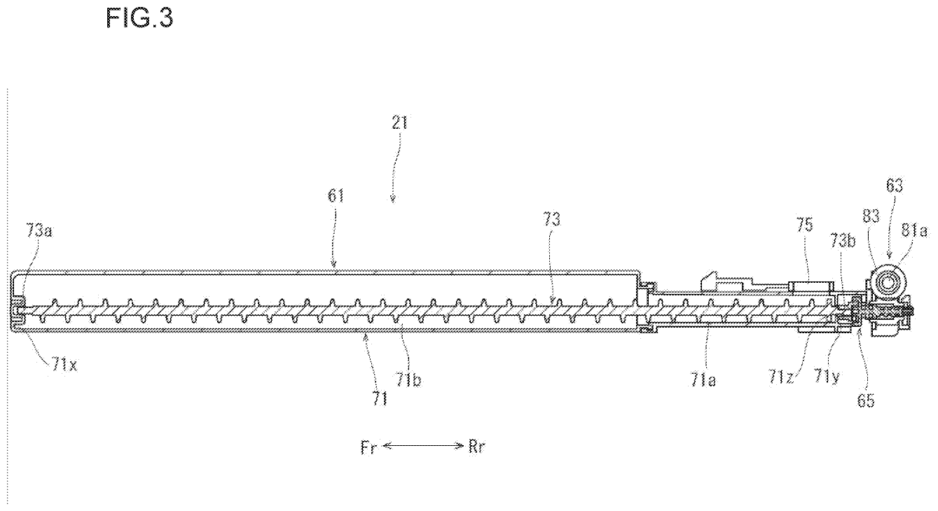

Next, with reference to FIGS. 2 and 3, the waste toner conveying device 21 will be described. FIG. 2 is a perspective view showing the waste toner conveying device 21, and FIG. 3 is a sectional view showing the waste toner conveying device 21. The waste toner conveying device 21 includes a waste toner bottle 61, a driving unit 63 disposed in the body 3, and a driving force transmission mechanism 65 that couples together the waste toner bottle 61 and the driving unit 63. The waste toner conveying device 21 is one example of a toner conveying device according to the present disclosure.

As shown in FIG. 3, the waste toner bottle 61 includes a housing 71 in which the waste toner removed from the intermediate transfer belt 51 is collected and a conveying screw 73 that is rotatably housed in the housing 71. The housing 71 is in the shape of a hollow rectangular parallelepiped elongate along the front-rear direction, and has a conveying portion 71a and a storage portion 71b, the latter having a higher volume than the former. The top wall of the conveying portion 71a has formed in it an opening 75 through which to receive waste toner.

As shown in FIG. 3, a front end part 73a and a rear end part 73b of the conveying screw 73 are rotatably supported on a front wall 71x and a rear wall 71y, respectively, of the housing 71. Specifically, the front end part 73a is supported on a bearing portion formed in the front wall 71x, and the rear end part 73b is supported in a through hole 71z formed in the rear wall 71y. On the outer circumferential face of the rear end part 73b, which protrudes rearward from the rear wall 71y, a D-cut face is formed parallel to the rotation axis direction of the conveying screw 73. As the conveying screw 73 rotates, the waste toner received through the opening 75 in the housing 71 is conveyed through the conveying portion 71a to the storage portion 71b. Thus, the conveying screw 73 is one example of a rotary member according to the present disclosure.

The waste toner bottle 61 is mounted and dismounted through the opening 9 (see FIG. 1) in the front side plate 3b of the body 3 along a mounting-dismounting direction along the front-rear direction. For example, on the occasion of disposal of the collected toner, the waste toner bottle 61 is pulled out of the body 3 to be dismounted from the body 3.

The driving unit 63 includes a motor 81 (see FIG. 2) as a driving source and a motor gear 83 fixed to the output shaft 81a of the motor 81. The motor 81 is supported on the body 3 such that the axial direction of the output shaft 81a points in a direction (left-right direction) orthogonal to the mounting-dismounting direction (front-rear direction) of the waste toner bottle 61. (The teeth of the motor gear 83 are not illustrated).

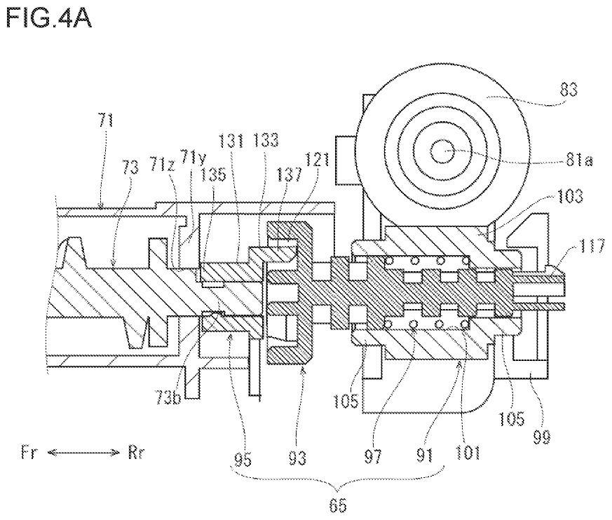

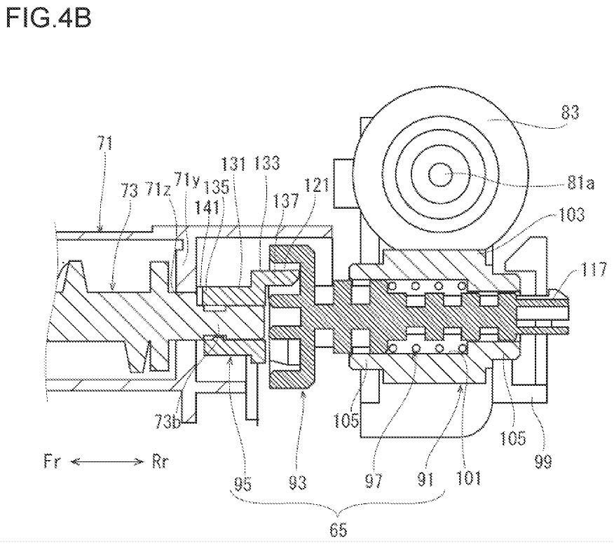

Next, the driving force transmission mechanism 65 will be described with reference to FIGS. 4A and 4B. FIGS. 4A and 4B are sectional views showing the driving force transmission mechanism 65. The driving force transmission mechanism 65 couples together the rear end part 73b of the conveying screw 73 in the waste toner bottle 61 and the motor gear 83 in the driving unit 63. When the waste toner bottle 61 is mounted along the mounting-dismounting direction, a driving force fed from the motor 81 via the driving force transmission mechanism 65 makes the conveying screw 73 rotate.

The driving force transmission mechanism 65 includes a driving gear 91 that meshes with the motor gear 83, a drive-side coupling 93 that rotates together with the driving gear 91, an output-side coupling 95 that is fixed to the rear end part 73b of the conveying screw 73, and a coil spring 97.

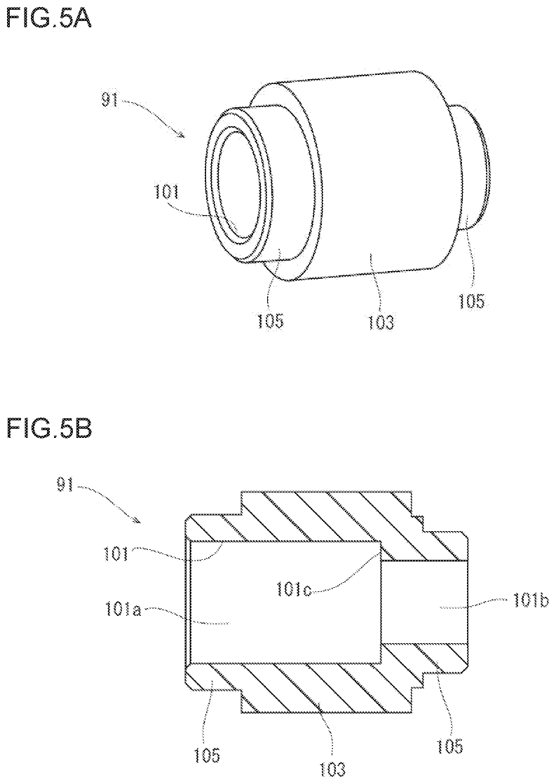

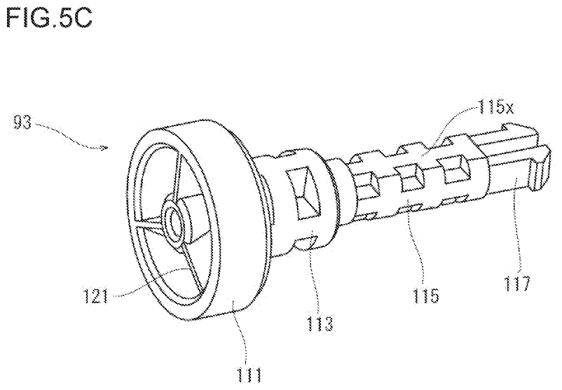

First, the driving gear 91 will be described with reference to FIGS. 4A, 4B, 5A, and FIG. 5A is a perspective view showing the driving gear 91, and FIG. 5B is a sectional view showing the driving gear 91. As shown in FIGS. 5A and 5B, the driving gear 91 is a member in a cylindrical shape and has a hollow space 101 along the rotation axis direction of the conveying screw 73. On the outer circumferential face of the driving gear 91, a helical gear 103 is formed. At opposite ends of the helical gear 103 along the rotation axis direction, bearing portions 105 are formed with a smaller diameter than the helical gear 103. As shown in FIG. 5B, the hollow space 101 has a large-diameter portion 101a and a small-diameter portion 101b, and between the large-diameter and small-diameter portions 101a and 101b, a step face 101c is formed. The large-diameter portion 101a is in a cylindrical shape, and the small-diameter portion 101b has a D-cut face formed parallel to the rotation axis direction. (The teeth of the helical gear 103 are not illustrated. The tooth traces of the helical gear 103 are, for example, inclined at 45 degrees relative to the rotation axis direction.)

As shown in FIGS. 4A and 4B, the bearing portions 105 of the driving gear 91 are both rotatably supported on a holder 99 that is supported on the body 3. The holder 99 supports the driving gear 91 with its large-diameter portion 101a at the front and its small-diameter portion 101b at the rear. The helical gear 103 on the driving gear 91 meshes with the motor gear 83 in the driving unit 63. Thus, when the motor 81 is driven and the output shaft 81a rotates, the driving gear 91 rotates about the rotation axis.

Next, with reference to FIGS. 4A, 4B, and 5C, the drive-side coupling 93 will be described. FIG. 5C is a perspective view showing the drive-side coupling 93. As shown in FIG. 5C, the drive-side coupling 93 has, along the rotation axis direction of the driving gear 91, a coupling portion 111, a large-diameter portion 113, a small-diameter portion 115, and a pair of hooks 117.

The coupling portion 111 is in a cylindrical shape open at the front, and has three engagement walls 121 along radial directions. Every two adjacent ones of the engagement walls 121 has an equal central angle. The large-diameter portion 113 is in a cylindrical shape with a smaller diameter than the coupling portion 111, and has an outer diameter generally equal to the diameter of the large-diameter portion 101a of the hollow space 101 in the driving gear 91. The small-diameter portion 115 has a shape similar to that of the small-diameter portion 101b of the hollow space 101 in the driving gear 91, and has a D-cut face 115x formed parallel to the rotation axis direction. The pair of hooks 117 is formed on an end face of the small-diameter portion 101b. The pair of hooks 117 has a maximum outer diameter larger than the outer diameter of the small-diameter portion 101b. The hooks 117 are elastically deformable inward along radial directions.

The drive-side coupling 93 is housed in the hollow space 101 in the driving gear 91. Specifically, as shown in FIGS. 4A, 4B, 5A, 5B, and 5C, the large-diameter portion 113 of the drive-side coupling 93 and part of its small-diameter portion 115 are fitted in the large-diameter portion 101a of the hollow space 101 in the driving gear 91 and the rest of the small-diameter portion 115 is fitted in the small-diameter portion 101b of the hollow space 101. Here, the D-cut face 115x on the small-diameter portion 115 of the drive-side coupling 93 makes contact with the D-cut face on the small-diameter portion 101b of the hollow space 101 in the driving gear 91. The hooks 117 protrude out of the small-diameter portion 101b.

As shown in FIGS. 4A and 4B, the coil spring 97 has a diameter such that the small-diameter portion 115 of the drive-side coupling 93 can be placed through it. The coil spring 97 is disposed in the hollow space 101 in the driving gear 91, between the step face 101c (see FIG. 5B) of the driving gear 91 and the large-diameter portion 113 (see FIG. 5C) of the drive-side coupling 93. The coil spring 97 urges the drive-side coupling 93 forward relative to the driving gear 91.

The drive-side coupling 93 is built into the driving gear 91, for example, in the following manner. First, the small-diameter portion 115 of the drive-side coupling 93 is placed through the coil spring 97. Then the drive-side coupling 93 is inserted, starting with the hooks 117, into the large-diameter portion 101a of the hollow space 101 in the driving gear 91. Eventually the hooks 117 make contact with the step face 101c and they then elastically deform inward in radial directions to be inserted into the small-diameter portion 101b. Once the hooks 117 protrude out of the small-diameter portion 101b, they elastically deform outward in radial directions. Thus, the pair of hooks 117 prevents the drive-side coupling 93 from dropping out of the driving gear 91. Moreover, the coil spring 97 is disposed between the step face 101c in the driving gear 91 and the large-diameter portion 113 of the drive-side coupling 93. Furthermore, the small-diameter portion 115 of the drive-side coupling 93 is inserted in the small-diameter portion 101b of the hollow space 101 in the driving gear 91, and the D-cut face 115x on the small-diameter portion 115 of the drive-side coupling 93 makes contact with the D-cut face on the small-diameter portion 101b of the hollow space 101 in the driving gear 91. Thus, the drive-side coupling 93 is built into the driving gear 91 so as to be rotatable together with the driving gear 91 and movable along the rotation axis direction relative to the driving gear 91.

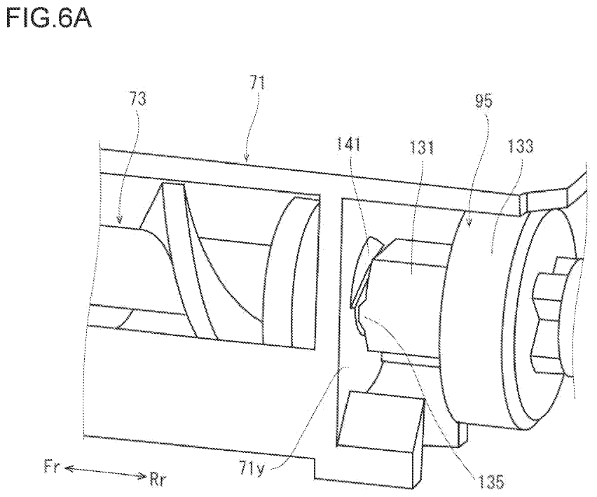

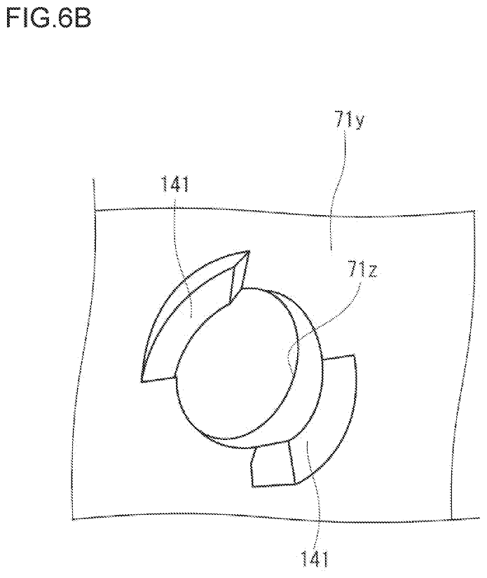

Next, with reference to FIGS. 4A, 4B, and 6A, the output-side coupling 95 will be described. FIG. 6A is a perspective view showing the output-side coupling 95. The output-side coupling 95 is a member in a cylindrical shape and has, as shown in FIGS. 4A and 4B, a fixed portion 131 that is fixed to the rear end part 73b of the conveying screw 73 and a coupling portion 133 that can couple with the coupling portion 111 of the drive-side coupling 93. On the inner circumferential face of the fixed portion 131, a D-cut face is formed parallel to the rotation axis direction. On the end face (front face) of the fixed portion 131, as shown in FIG. 6A, a pair of projections 135 is formed. The fixed portion 131 is fitted in the rear end part 73b of the conveying screw 73 and is fixed to the rear end part 73b. The D-cut face on the fixed portion 131 makes contact with the D-cut face on the rear end part 73b. Thus, the conveying screw 73 rotates together with the fixed portion 131, that is, together with the output-side coupling 95. The coupling portion 133 has three engagement parts 137 along its circumferential direction. Every two adjacent ones of the engagement parts 137 have an equal central angle.

A description will now be given of how waste toner is conveyed in the waste toner conveying device 21 configured as described above. As described above, when the waste toner bottle 61 is mounted in the body 3 along the mounting-dismounting direction, the output-side coupling 95 fixed to the rear end part 73b of the conveying screw 73 couples with the drive-side coupling 93 housed in the driving gear 91 meshed with the motor gear 83 in the driving unit 63. Specifically, the three engagement parts 137 on the coupling portion 133 of the output-side coupling 95 fit in the spaces partitioned by the three engagement walls 121 in the coupling portion 111 of the drive-side coupling 93. Moreover, the drive-side coupling 93 is urged frontward by the coil spring 97, and the projections 135 on the fixed portion 131 make contact with the rear wall 71y of the housing 71. Thus, the coil spring 97 is one example of an urging member according to the present disclosure, and the rear wall 71y of the housing 71 is one example of a contact wall according to the present disclosure.

As the motor 81 in the driving unit 63 is driven, via the motor gear 83 the driving gear 91 rotates and, together with the driving gear 91, the drive-side coupling 93 rotates. The three engagement walls 121 in the coupling portion 111 of the drive-side coupling 93 then make contact with the three engagement parts 137 on the coupling portion 133 of the output-side coupling 95 and make the output-side coupling 95 rotate about its rotation axis. As a result, together with the output-side coupling 95, the conveying screw 73 rotates. The waste toner received through the opening 75 in the housing 71 is then conveyed frontward by the conveying screw 73. The waste toner is conveyed through the conveying portion 71a to a front end part of the storage portion 71b so as to be stored rearward starting in the front end part.

When the housing 71 becomes full with the collected waste toner, the waste toner bottle 61 is pulled out frontward to decouple the output-side coupling 95 from the drive-side coupling 93.

In known image forming apparatuses, a driving force transmission mechanism is configured, for example, as follows. The driving force transmission mechanism transmits a driving force fed from a driving source to a rotary member to rotate it. The driving force transmission mechanism includes a first coupling member (device-side coupling) that is driven to rotate and a second coupling member (output-side coupling) that couples with the first coupling member. The first coupling member is supported on a boss portion. The boss portion is provided on the rotation axis of a driving gear. The first and second coupling members are designed such that they can be coupled together reliably. A coil spring is disposed between the second coupling member and the boss portion. The coil spring is covered from around by a positioning cylindrical portion.

In known image forming apparatuses, the driving force transmission mechanism needs to include at least a first coupling member, a second coupling member, a coil spring, and a positioning cylindrical portion. Moreover, a boss portion needs to be provided on a driving gear, and this complicates the design of the driving gear. Furthermore, the driving gear and the first and second coupling members are located next to each other along the rotation axis. For their arrangement, it is necessary to secure a space with a predetermined length along the rotation axis direction.

By contrast, as will be clear from the above description, with the driving force transmission mechanism 65 according to the present disclosure, the drive-side coupling 93 and the coil spring 97 are housed in the hollow space 101 in the driving gear 91. This helps reduce the length of the driving force transmission mechanism 65 along the rotation axis direction. Also, there is no need, as in the known example, for a member for housing the coil spring 97 and a boss portion for supporting the drive-side coupling 93. This helps reduce the number of components of the driving force transmission mechanism 65 and helps simplify the shape of the driving gear 91.

Moreover, as shown in FIGS. 6A and 6B, on the rear face of the rear wall 71y of the housing 71, a pair of projections 141 may be formed. The pair of projections 141 is formed around the through hole 71z in the rear wall 71y, so as to be increasingly high along the rotation direction of the output-side coupling 95.

As described above, the pair of projections 135 on the output-side coupling 95 makes contact with the rear wall 71y of the housing 71. As the output-side coupling 95 rotates, the pair of projections 135 on the output-side coupling 95 make contact with, alternately, the projections 141 on the rear wall 71y and the part of it other than the projections 141. Thus, the output-side coupling 95, hence the conveying screw 73, reciprocates along the rotation axis direction.

Specifically, when the pair of projections 135 on the output-side coupling 95 moves up onto the pair of projections 141, then as shown in FIG. 4B the output-side coupling 95 moves toward the drive-side coupling 93 against the urging force of the coil spring 97. That is, the conveying screw 73 moves rearward. When as shown in FIG. 4A the pair of projections 135 on the output-side coupling 95 moves down off the pair of projections 141, the output-side coupling 95 is urged by the coil spring 97, so that the pair of projections 135 makes contact with the rear wall 71y. That is, the conveying screw 73 moves frontward. In this way, the conveying screw 73 reciprocates along the front-rear direction. Thus, the conveying screw 73 vibrates to convey waste toner while breaking the lump of it. It is thus possible to smoothly convey waste toner and efficiently collect it.

As described above, according to the present disclosure, a drive-side coupling is housed in a hollow space in a drive gear, and this helps reduce the length of a driving force transmission mechanism along the rotation axis direction of a rotary member.

While the embodiment described above deals with an example where the driving force transmission mechanism 65 couples between the conveying screw 73 for conveying waste toner and the motor 81, a driving force transmission mechanism 65 according to the present disclosure may be used to couple between a rotary member and a driving source for driving it, such as between a toner conveying screw in a development device and a motor. The embodiment described above deals with an example where the coil spring 97 urges the drive-side coupling 93 toward the output-side coupling 95. Instead, any other urging member may be used in place of the coil spring 97; any other urging member may urge the output-side coupling 95 toward the drive-side coupling 93.

While the present disclosure discusses a specific embodiment, its application is not limited to the embodiment described above. Those skilled in the art can modify the embodiment described above in many ways without departure from the scope and spirit of what is disclosed herein.

What is claimed is:

1. A driving force transmission mechanism for transmitting a driving force fed from a driving source to a rotary member, the driving force transmission mechanism comprising:
a driving gear that rotates by being fed with the driving force from the driving source, the driving gear having a hollow space along a rotation axis direction;
a drive-side coupling that is inserted in the hollow space in the driving gear, the drive-side coupling rotating together with the driving gear;
an output-side coupling that is integral with the rotary member, the output-side coupling being couplable with the drive-side coupling along the rotation axis direction; and
an urging member that urges one of the drive-side coupling and the output-side coupling toward another along the rotation axis direction.

2. The driving force transmission mechanism according to claim 1, wherein
the urging member is housed in the hollow space in the driving gear, and urges the drive-side coupling toward the output-side coupling.

3. A toner conveying device, comprising:
a rotary member that rotates with a driving force fed from a driving source to convey toner; and
the driving force transmission mechanism according to claim 1 that transmits the driving force from the driving source to the rotary member.

4. The toner conveying device according to claim 3, further comprising:
a housing in which the rotary member is housed;
a contact wall that is provided in the housing and with which the output-side coupling makes contact when the urging member urges the drive-side coupling toward the output-side coupling; and
a projection formed on a part of a face of the contact wall facing the drive-side coupling,
wherein
the rotary member rotates while reciprocating between a position where the output-side coupling makes contact with the projection on the contact wall and a position where the output-side coupling makes contact with a part of the contact wall other than the projection.

5. The toner conveying device according to claim 4, wherein
the rotary member is a conveying screw for conveying waste toner removed from an image carrying member to a waste toner bottle.

6. An image forming apparatus comprising the toner conveying device according to claim 5.
